(19) United States
(12) Patent Application Publication
(10) Pub. No.: US 2009/0258428 A1
(43) Pub. Date: Oct. 15, 2009

(54) METHOD FOR ANALYZING LOW MOLECULAR WEIGHT COMPOUND IN SAMPLE CONTAINING WATER-SOLUBLE POLYMER AND LOW MOLECULAR WEIGHT COMPOUND

(75) Inventors: Yoshiji OKada, Kanagawa (JP); Kuniaki Shimbo, Kanagawa (JP); Hideyuki Kondo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 11/996,524

(22) PCT Filed: Jul. 25, 2006
(86) PCT No.: PCT/JP2006/315096

§ 371 Date: Jan. 23, 2008

(30) Foreign Application Priority Data
Jul. 26, 2005 (JP) 2005-215930

(51) Int. Cl. G01N 33/487; C08L 31/06; B01D 15/08

(52) U.S. Cl. 436/88; 524/558; 210/198.2

(57) ABSTRACT

The invention relates to an analysis method which can conduct analysis on low molecular weight compound in a sample containing water-soluble polymer and low molecular weight compound under isocratic conditions without being affected by proteins or the like and in which water-soluble polymer and low molecular weight compound can be separated efficiently and to a column for such an analysis by high performance liquid chromatography, packed with a packing material comprising a crosslinked organic polymer compound obtained by polymerizing glycerin dimethacrylate at 90 mass % or more as starting material, having the exclusion limit molecular weight measured with pullulan of 30000 or less but 3000 or more and having a mass average particle diameter of 0.1 to 100 μm.

### TECHNICAL FIELD

The invention relates to a method for analyzing low molecular weight compound in a sample containing water-soluble polymer and low molecular weight compound with a high performance liquid chromatography (hereinafter, sometimes simply referred to “HPLC”). Specifically, it relates to a method for isolating and analyzing a small amount of low molecular weight compound (especially, polar low molecular weight compound) in a sample containing biological polymer compound (such as protein) which is usually contained in a biological sample. More specifically, it relates to an analysis method which can conduct analysis on low molecular weight compound such as drug metabolites without being affected by ion suppression or the like even in a case where a mass analyzer (hereinafter, sometimes simply referred to “MS” (mass spectrograph)) is used as a detector in analyzing a sample containing a protein such as serum albumin mostly contained in biological components.

### BACKGROUND ART

In a case where low molecular weight in a sample containing water-soluble polymer, especially proteins such as serum albumin and low molecular weight compounds such as drug metabolites contained in the living body is analyzed, most of the proteins as interfering components are removed in advance through addition of organic solvent or solid-phase extraction and then analysis is conducted. However, it is difficult to remove all such proteins in this manner and often a small amount of proteins, which cannot be removed, remains in the sample.

There is a problem that when such a sample is analyzed by using a conventional silica type packing material called “ODS (octadecyl group bonded silica gel)”, the small amount of protein is irreversibly adsorbed onto the column, which leads to acceleration of deterioration of the column or changes in separation pattern. As a method which can avoid such a problem, developments are made on column switching method and a method using column with a packing material called permeation controlling packing material.

In order to complement defects in such a silica-gel packing material, developments are made on those using porous organic polymer as base material of packing material. For example, when a column using a packing material comprising polyvinyl alcohol as base material is used, for its hydrophilicity, the column does not adsorb much of protein or the like and protein is eluted out of the column earlier without being adsorbed. However, since the base material itself is slightly hydrophobic, it can retain low molecular weight compound through hydrophobic interaction. Thus, low molecular weight compound can be separated from proteins or the like and analyzed.

In JP 2003-93801 A, a porous polymer particle characterized by the pore volume and the surface area and having a hydrophilic layer on its surface is described. In JP 20001-66295 A and JP 2003-194793 A, packing material synthesized by using a compound containing polyethyleneglycol skeleton as crosslinking monomer is described. As for this packing material, function as a concentration column used in column switching method is introduced.

The column using organic polymer as packing material has a property free from adsorption of hydrophilic polymer (especially, in this case, serum albumin which is often contained in biological samples). However, in a case where analysis is conducted on a sample containing water-soluble polymer and low molecular weight compound with such a column, analysis on highly polar low molecular weight compound is a concern. Such a compound having little hydrophobicity, separation from water-soluble polymer by using a normal hydrophobic packing material is insufficient. Moreover, in contrast, when a packing material which retains highly polar low molecular weight substance well is used, its hydrophobicity is too strong and as a whole, the retention time of low molecular weight compound is too large, which causes the analysis to take too long a time under isocratic condition (condition with constant eluent composition) and is inconvenient to be used for an analysis column.

The problems can be sometimes avoided by using eluent under gradient condition, but, gradient condition involves another problem. That is, it becomes a hindrance to the quantitative determination, in that with influences of changes in eluent composition and in pressure due to pump changeover according to the gradient condition, water-soluble polymer such as albumin having adsorbed on pipes or a column housing begins to elute out little by little and hinders ionization of low molecular weight drug in case of analyzing low molecular weight substance with MS, to thereby decrease detection sensitivity (ion suppression).

Under these circumstances, a packing material which has a strong property to retain highly polar low molecular weight compound and can separate well low molecular weight compound from water-soluble polymer and at the same time which enables quick analysis and can be used under isocratic condition, and an analysis method using the packing material, have been demanded.

A porous separator consisting of organic polymer obtained by using glycerin dimethacrylate at 90% or more, which is preferably used in the present invention, is described in JP 58-32164 A, however, there is no description about method for analyzing low molecular weight compound in a sample containing water-soluble polymer and low molecular weight compound by using the packing material.

### DISCLOSURE OF THE INVENTION

The object of the invention is to solve the above problems in conventional technique. That is, the invention provides a method which can quickly analyze low molecular weight compound in a sample containing water-soluble polymer and low molecular weight compound under isocratic condition with constant eluent composition, with the low molecular weight compound being well separated from water-soluble polymer, without being influenced by protein or the like.

Based on presumptions that the essential requirements for a packing material which can solve the above problems are that no highly hydrophobic group (such as octadecyl group) should be contained for the purpose of avoiding a problem of adsorbing serum albumin or the like which is contained at a large amount in a biological sample as water-soluble polymer and is readily adsorbed and hinders the analysis and that the packing material should have hydrogen-bonding property for the purpose of separating polar low molecular weight compound from water-soluble polymer both contained in the same sample, the present inventors have made intensive studies. As a result, the inventors have succeeded in solving the above problems and completed the invention. That is, the invention relates to a method for analyzing low molecular weight compound in a sample containing water-soluble polymer and low molecular weight compound as described in the following 1 to 10, a packing material used in liquid chromatography for analysis in the following 11, and a column used in liquid chromatography for analysis on low molecular weight compound in a sample containing water-soluble polymer and low molecular weight compound in the following 12.

1. A method for analyzing low molecular weight compound in a sample containing water-soluble polymer and low molecular weight compound, wherein the analysis is conducted by using a high-performance liquid chromatography which uses a column using a packing material comprising crosslinked organic polymer obtained by using as starting material monomer a compound having two ethylenic carbon-carbon double bonds and one hydroxyl group at 90 mass % or more.
2. The analysis method according to 1, wherein the compound having two ethylenic carbon-carbon double bonds and one hydroxyl group is glycerin dimethacrylate.
3. The analysis method according to 1 or 2, wherein the exclusion limit molecular weight of the packing material measured with pullulan is 30000 or less.
4. The analysis method according to any one of 1 to 3, wherein the high performance liquid chromatography analysis is conducted under isocratic condition by using an eluent containing 15 to 40 mass % of organic solvent compatible with water and 85 to 60 mass % of aqueous buffer.
5. The analysis method according to 4, wherein the organic solvent compatible with water is methanol and/or acetonitrile.
6. The analysis method according to 5, wherein the organic solvent compatible with water is acetonitrile.
7. The analysis method according to any one of 1 to 6, wherein the water-soluble polymer is contained in biological components and is derived from the living body.
8. The analysis method according to any one of 1 to 6, wherein the water-soluble polymer is serum albumin.
9. The analysis method according to any one of 1 to 8, wherein the packing material used in the method consists of porous spherical particles having a mass average particle diameter of 0.1 to 100 μm.
10. The analysis method according to any one of 1 to 9, wherein the low molecular weight compound separated by high performance liquid chromatography is analyzed by using a mass analyzer.
11. A packing material used in analysis on low molecular weight compound in a sample containing water-soluble polymer and low molecular weight compound with high performance liquid chromatography, consisting of a crosslinked organic polymer compound obtained by using glycerin dimethacrylate at 90 mass % or more as raw material,
having the exclusion limit molecular weight measured with pullulan of 30000 or less but 3000 or more and having a mass average particle diameter of 0.1 to 100 μm.
12. A column used in analysis on low molecular weight compound in a sample containing water-soluble polymer and low molecular weight compound with high performance liquid chromatography, using the packing material described in 11.

By using the method of the invention, low molecular weight compound in a sample containing water-soluble polymer and low molecular weight compound can be measured quickly under isocratic condition.

Particularly, in a case of using a mass analyzer (MS) as a detector, the measurement can be conducted without being affected by ion suppression or the like by a small amount of protein eluting.

### BRIEF DESCRIPTION OF DRAWINGS

FIG. 1 shows a calibration curve representing relationship between molecular weight of the substance analyzed and elution volume of the eluent and also shows the exclusion limit molecular weight, in size-exclusion chromatography.

FIG. 2 shows the chromatogram of Example 1. Peaks 1, 2 and 3 indicate the peaks of BSA, caffeine and toluene, respectively.

FIG. 3 shows the chromatogram of Comparative Example 1. Peaks 1, 2 and 3 indicate the peaks of BSA, caffeine and toluene, respectively.

FIG. 4 shows the chromatogram of Comparative Example 2. Peaks 1, 2 and 3 indicate the peaks of BSA, caffeine and toluene, respectively.

FIG. 5 shows the chromatogram of Comparative Example 3. Peaks 1, 2 and 3 indicate the peaks of BSA, caffeine and toluene, respectively.

FIG. 6 shows the chromatogram of Example 2 using UV detector (sample containing no BSA) and MS (sample containing no BSA).

FIG. 7 shows the chromatogram of Example 2 using UV detector (sample containing BSA) and MS (sample containing BSA).

### BEST MODE FOR CARRYING OUT THE INVENTION

### Packing Material

The packing material of the invention is a crosslinked organic polymer obtained by polymerization of a raw material monomer mixture solution containing a compound having two ethylenic carbon-carbon double bonds and one hydroxyl group at 90 mass % or more. By subjecting the monomer mixture solution to suspension polymerization, a fine particulate packing material can be obtained.

Samples serving as analyzed objects in the invention are those containing both water-soluble polymer and low molecular weight compound. The contained water-soluble polymer itself is not to be analyzed but has only to be separated from the low molecular weight compound and eluted out quickly. Samples used in the invention are mostly those derived from the living body. Accordingly in most cases, low molecular weight compounds to be analyzed are those having high polarity. The retention degree at which the packing material retains such a highly polar low molecular weight compound is determined by the sum of both electrostatic interaction (hydrogen-bonding property or dipole interaction) and hydrophobic interaction of the compound with the packing material. In a case where the retention is to be enhanced by hydrophobic interaction, elution of other strongly hydrophobic low molecular weight compounds co-existing in the sample is retarded, which hinders quick completion of the analysis. Therefore, as a packing material which is suitable for quick analysis and enables separation of highly polar low molecular weight compound from water-soluble polymer, those capable of well retaining highly polar low molecular weight compound mainly through hydrogen-bonding property are preferred. As a packing material separating these low molecular weight substances, it is preferable to have an appropriate degree of hydrogen-bonding property, and from this point of view, hydroxyl group is introduced in the invention. Presence of too many hydroxyl groups would result in too high a polarity of the packing material, which leads to too weak hydrophobic interaction. The packing material of the invention is required to have an extremely sensitive balance between hydrophobicity and hydrogen-bonding property.

### Starting Material Monomer:

As a packing material satisfying such a requirement, a crosslinked organic polymer which is obtained by using as raw material monomer, a compound having two ethylenic carbon-carbon double bonds and one hydroxyl group at 90 mass % or more. The two ethylenic carbon-carbon double bonds are necessary to introduce a cross-linked structure at the time of polymerization. There needs to be an appropriate distance between the two ethylenic carbon-carbon double bonds, but, when the distance is too far, the crosslinks in the packing material become sparse and swelling and contraction become large, which disadvantageously gives rise to decrease of packing material strength. The preferred number of covalent bonds between the carbon-carbon double bonds is from 6 to 10. Although hydroxyl group gives hydrogen-bonding property to the packing material, too many hydroxyl groups would decrease hydrophobicity of the packing material and the packing material could not be used in analysis. Therefore, one hydroxyl group per starting material monomer is appropriate.

Examples of compound having two ethylenic carbon-carbon double bonds and one hydroxyl group include di(ethylenically unsaturated carboxylic acid) esters of polyvalent alcohol having three or more hydroxyl groups or compounds in which ester bond in such a diester is substituted by an ether bond or single bond, such as glycerine di-1,3-(meth)acrylate, glycerine di-1,2-(meth)acrylate, 2-hydroxy-1,3-diallyloxypropane and 2-hydroxy-1,3-divinyloxypropane. Here, the term “(meth)acrylate” means “methacrylate” and also includes “acrylate”. Particularly preferred among them are glycerine dimethacrylate (2-hydroxy-1,3-dimethacryloxypropane). Hereinafter, glycerine dimethacrylate is explained as one example.

When a monomer having lower hydrophobicity than glycerine dimethacrylate, for example, acrylamide is used in combination with a cross-linking agent (polyfunctional monomer) or the like, hydrophobicity of the packing material becomes too low, which is not preferred. In contrast, when a monomer having high hydrophobicity, for example, divinylbenzene or the like is used, hydrophobicity of the packing material becomes too high, which significantly retards elution of low molecular weight compound having hydrophobicity to thereby lengthen the analysis time, which is not preferred.

Since glycerine dimethacrylate is a crosslinking monomer, the packing material obtained from glycerine dimethacrylate has high crosslinking degree with high strength. Therefore, the diameter of packing material particles can be small and thus, a high-performance packing material to be used in liquid chromatography can be obtained. In contrast, when non-crosslinking monomer is used instead of glycerine dimethacrylate, strength of the obtained packing material is lost as much, which is not preferred. As an example of a monomer serving as crosslinking agent, having similar hydrophobic degree with glycerine dimethacrylate, polyethylene glycol dimethacrylate having a long molecular chain between crosslinking sites may be mentioned, but, when such a compound is used, swelling and contraction increase, which disadvantageously decreases strength of the packing material.

The concentration of glycerine dimethacrylate in raw material monomer mixture is required to be 90 mass % or more, more preferably 95 mass % or more, even more preferably 99 mass % or more. When the concentration is less than 90 mass %, hydrogen-bonding property becomes low, which may lead to insufficient separation of highly polar low molecular weight compound and is not preferred. When the concentration is 90 mass % or more, a packing material with sufficient strength, high hydrogen-bonding property and small hydrophobicity can be obtained.

The separating property and other properties of the packing material of the invention can be controlled by blending other monomers into the raw material mixture within a range that the concentration of glycerine dimethacrylate does not fall short of 90 mass %. Examples of monomers to be added other than glycerine dimethacrylate include most of radically polymerizable monomers which are employed in producing conventional packing materials, specifically include styrene, divinylbenzene, methyl acrylate, bis(meth)acrylamide, ethyl (meth)acrylate, hydroxyethyl (meth)acrylate, glycidyl (meth)acrylate, ethylene glycol di(meth)acrylate, (meth)acrylamide and glycerine mono(meth)acrylate.

### Polymerization:

Polymerization may be conducted through normal radical polymerization such as solution polymerization, mass polymerization, suspension polymerization and emulsification polymerization. Hereinbelow, a representative example where spherical particles are prepared through aqueous suspension polymerization is explained, however, the polymerization method is not limited to this method.

Oil phase used in aqueous suspension polymerization is prepared by adding a polymerization initiator to mixture of raw material monomer mixture and a diluent (solvent or dispersion medium, used to dilute the monomer with).

The diluent is added to the monomer mixture for the purpose of making the generated spherical crosslinked organic polymer particles (packing material) porous. The type of diluent is not particularly limited in cases like mass polymerization where water is not used as a medium. However, in cases like aqueous suspension polymerization where water is used as a medium, it is preferred to use an organic compound having poor water-solubility. Specific examples thereof include toluene, xylene, diethylbenzene, heptane, octane, dodecane, butyl acetate, dibutyl phthalate, isoamyl alcohol, 1-hexanol, cyclohexanol, 2-ethyl hexanol, 1-dodecanol and non-crosslinking polystyrene. One of these solvents or dispersion media may be used singly or a mixture of two or more of them may be used.

Moreover, the range of the amount of the diluent to be added is from 10 to 90 mass %, preferably from 20 to 80 mass %, more preferably 25 to 60 mass %, based on the total amount of the raw material monomer and the diluent. When the amount is less than 10 mass %, porosity of the packing material is insufficient, which is not preferred. When a large amount of diluent is used, the pore volume of the packing material becomes large, which is preferred, but when the amount exceeds 90 mass %, the physical strength of the packing material is insufficient and pressure resistance when used in a column decreases.

Examples of polymerization initiator include widely used ones including azo compounds such as 2,2-azobis(isobutyronitrile) and 2,2′-azobis(2,4-dimethylvaleronitrile); and

organic peroxides such as benzoyl peroxide, dicumyl peroxide, di-tert-butyl peroxide, t-butyl perbenzoate and methylethyl ketone peroxide. One of these compounds may be used singly or a mixture of two or more of them may be used. Although the concentration of polymerization initiator used is appropriately selected depending on the type of monomer and cannot be flatly defined here, a preferred range is 0.1 to 5 parts by mass, assuming that the total amount of monomer is 100 parts by mass.

Into water phase, oil-phase dispersion stabilizer is added. Examples of dispersion stabilizer include water-soluble polymer compounds such as polyvinyl alcohol, alkyl cellulose, hydroxy-alkyl cellulose, carboxyalkyl cellulose, sodium polyacrylate and gelatin. The concentration of the dispersion stabilizer is not particularly limited, but a preferred range is 0.1 to 5 parts by mass based on 100 parts by mass of water. Moreover, in order to prevent part of monomer from being dissolved into water phase, it is preferable to add salts to the water phase. Example of salts include sodium chloride, calcium chloride and sodium sulfate. One of these salts may be used singly or a mixture of two or more of them may be used. The concentration of salt used is not limited, the higher, the better, as far as solubility allows. Specifically, in case of sodium chloride, from 1 to 15 parts by mass, and in case of calcium chloride, from 1 to 40 parts by mass, based on the water amount.

When the ratio of the water phase is too large against the oil phase, the amount of monomer dissolved into the water phase increases. In contrast, when the ratio is too small, oil droplet coalescence readily occurs. Therefore, a preferred mass amount of water used is from 200 to 1000 parts by mass, assuming that the total amount of the monomer and the diluent is 100.

Before initiating aqueous suspension polymerization, oil phase and water phase are mixed together to disperse oil droplet so that a desired particle diameter (diameter) of oil droplet may be obtained. For dispersion, a stirrer having a stirring blade used for microparticulation or a high-speed disperser (homogenizer) may be used. It is advantageous, that in preparing adsorbent having a relatively large particle diameter (for, example, one used in solid-phase extraction), a stirrer having a stirring blade used for microparticulation is used, and that in preparing adsorbent having a small particle diameter, a high-speed disperser (homogenizer) is preferably used.

Polymerization reaction is conducted at a temperature range of 40 to 100° C. under a general stirring condition for 5 to 16 hours.

The thus obtained fine particles of packing material are sufficiently washed with hot water or organic solvent to thereby remove dispersion stabilizer, solvent remaining monomer, diluent and the like contained in or attached on the particles. Further, if necessary, the particles are subjected to classification, to thereby obtain a packing material for chromatography.

### Particle Diameter of Packing Material:

It is necessary to use fine particles so that a sufficient number of theoretical plates may be obtained in HPLC. The mass average particle diameter of the packing material is preferably from 1.0 to 100 μm, more preferably from 110 μm, even more preferably from 3 to 5 μm. When the particle diameter is less than 0.1 μm, the pressure in the column becomes too high, which may cause a malfunction to the apparatus. When the diameter exceeds 100 μm, analysis performance of the column deteriorates, which is inconvenient. In order to obtain a desired particle diameter, the stirring rate or the amount of dispersant at the polymerization is adjusted. By examining the relationship between the obtained diameter of the packing material as final product and these conditions, optimum conditions can be determined. Alternatively, particles obtained from polymerization can be classified. Examples of classification procedures include sieving and air classification.

The mass average particle diameter can be measured by use of a Coulter Counter (Registerd trademark) or an optical microscope.

The above is explanation on a case where the packing material consists of porous particles. The packing material may be monolithic stationary phase as far as it is porous.

### Exclusion Limit Molecular Weight of the Packing Material:

It is preferable that the packing material of the invention have an exclusion limit molecular weight of 30000 or less. When the exclusion limit molecular weight exceeds 30000, elution of water-soluble polymer such as serum albumin is retarded and thus separation from low molecular weight compound does not proceed efficiently. When the exclusion limit molecular weight is less than 3000, retention of low molecular weight compound to be analyzed decreases or separation deteriorates, which is not preferred.

The exclusion limit molecular weight is determined by packing a stainless column having an inner diameter of 4.6 mm and a length of 150 mm with the packing material and preparing a calibration curve with Pullulan (produced by SHOWA DENKO K.K.) having a known molecular weight serving as a standard by using pure water as eluent. In a case where the exclusion limit molecular weight is 30000 or less, most of water-soluble protein mainly contained in the living body is eluted at a point close to the exclusion limit (Vo). On the other hand, since low molecular weight compounds, which are eluted sequentially according to the hydrophobic degree of each compound after permeability limit (Vt), separation between water-soluble polymer and low molecular weight compound is improved. Based on these facts, the value of the exclusion limit molecular weight is important in terms of improvement in separation between water-soluble polymer and low molecular weight compound.

In a case where the packing material of the invention is produced through normal procedure such as suspension polymerization, the exclusion limit molecular weight of the packing material can be controlled by the amount and type of diluent to be added together with monomer. Generally, by increasing the amount of diluent, the pore size of packing material particles increases and the exclusion limit molecular weight becomes larger. When a poor solvent which poorly dissolves polymer obtained by polymerization of the monomer used is employed as diluent, the exclusion limit molecular weight becomes large while when a good solvent is employed, the exclusion limit molecular weight becomes small.

### Analyzed Object:

The term “water-soluble polymer” means protein, organic polymer and natural polymer having a molecular weight of about 10000 or more. Particularly, it includes water-soluble polymer derived from the living body and further includes serum albumin, albumin dimer and the like which mostly are contained in biological samples and tend to interfere the analysis.

In the present Specification, the term “low molecular weight compound” means an organic compound having a molecular weight of 4000 or less. Especially, when the biological sample or the like is provided for analytical purpose, drugs and drug metabolites contained in the sample can be mentioned as low molecular weight compound. Specific examples thereof include caffeine, theobromine theophylline and barbital.

The packing material of the invention, in spite of its low hydrophobicity, has a remarkably high hydrogen-bonding property as compared with conventional reversed-phase analysis columns. Therefore, the packing material has a property of high retention for highly polar low molecular weight compound such as caffeine. This property is one of the factors which realize the analysis method of the invention. The reason for this high hydrogen-bonding property can be assumed to be influence by hydroxyl groups that are scattered about not only on the particle surface but also inside pores. However, the details are not known.

The column of the present invention preferably has a shown by the following equation,

α=k_{caffeine}/kₜₒₗᵤₑₙₑ

[k_{caffeine}: retention coefficient of caffeine,
kₜₒₗᵤₑₙₑ: retention coefficient of toluene,
kᵣ: (tᵣ−t₀)/t₀, r: caffeine or toluene
tᵣ: retention time of each sample (time point at a peak),
tₒ: non-retention time]
in a range of 0.05 to 1.0, more preferably 0.08 to 0.5. If the value α is less than the lower limit, the separation of polar low-molecular-weight compound from water-soluble polymer becomes insufficient while if the value exceeds the upper limit, the separation between polar low-molecular-weight compound and hydrophobic compound becomes worse.
Analysis Conditions with High-Performance Liquid Chromatography:

### <Eluent>

In the analysis method of the invention, as eluent for HPLC, it is preferable to use an eluent containing 15 to 40 mass % of an organic solvent compatible with water and 85 to 60 mass % of aqueous buffer.

The term “organic solvent compatible with water” means an organic solvent which can be dissolved in water (inclusive of aqueous buffer) at a concentration of 25 mass % or more at a temperature range of room temperature to the HPLC analysis temperature. Such an organic solvent is not particularly limited as far as it can be used in normal liquid chromatography. Examples thereof include methanol, ethanol and acetonitrile, and particularly preferred is acetonitrile. Several types of these compounds may be used in mixture.

As aqueous buffer, various buffers may be used for the purpose of stabilizing the pH upon analysis. Alternatively, instead of using aqueous buffer, pure water may be employed. In a case where an MS is employed as a detector, use of volatile buffer is desirable. Preferred examples include ammonium formate and ammonium acetate. Generally used is 5-10 mM ammonim acetate aqueous solution.

The preferred blending ratio between the organic solvent compatible with water and the aqueous buffer is from 15 to 40 mass %: from 85 to 60 mass %, more preferably from 20 to 35 mass %: from 80 to 65 mass %, most preferably from 20 to 30 mass %: from 80 to 70 mass %.

It is not always true that the packing material of the invention adsorbs no protein such as serum albumin. However, under a preferred eluent condition where the packing material is used, with the concentration of the organic solvent being from 15 to 40 mass %, the hydrophobic interaction with proteins such as serum albumin can be lowest and the packing material adsorbs little protein. Therefore, when the analysis is conducted within this eluent condition, the recovery rate of albumin is 90% or higher and at the same time, the retention rate of hydrophilic low molecular weight compound by the packing material is also sufficiently high, and also, highly hydrophobic compound can also be eluted without being retarded. Thus, the HPLC analysis can be advantageously conducted under an isocratic condition. Under a condition where the concentration of the organic solvent is less than 15 mass %, not only some adsorption of proteins such as serum albumin can be observed but also elution of highly hydrophobic compound is too much retarded. In contrast, under a condition where the concentration of the organic solvent exceeds 40 mass %, retention of highly polar low molecular weight compound becomes insufficient and with the permeability limit getting closer, separation becomes inefficient. Further, under such a condition, proteins such as serum albumin show poor solubility and might precipitate, which is not preferred.

It is preferable that the HPLC analysis according to the invention be conducted under isocratic condition of eluent. This is because elution of hydrophilic polymer adsorbed on the column housing or piping can be reduced to the minimum. This is especially preferable in a case where an MS is connected as a detector or a case where quantitative determination of low molecular weight compound is stably conducted. However, in a case where observation is conducted without an MS or a case where merely washing of the column or analyzer is conducted, a gradient condition may be employed without any problem.

### EXAMPLES

Hereinafter, the invention will be explained by referring to Examples and Comparative Examples. However, the invention is by no means limited thereto.

### Example 1

### 1. Synthesis of Glycerine Dimethacrylate Packing Material

Into a mixture of 2000 g of glycerine dimethacrylate (NK ester 701, produced by Shin-nakamura Chemical Corporation) and 1340 g of cyclohexanol (produced by JUNSEI CHEMICAL Co. Ltd.), 30 g of 2,2′-azobis(isobutyronitrile) (produced by Wako Pure Chemical Industries, Ltd.) was dissolved to prepare the oil phase. On the other hand, 120 g of polyvinylalcohol (Kuraray Poval PVA-224, produced by KURARAY CO., LTD.) was dissolved in 3 l of water, and thereto added and mixed together were 7 l of water and then a solution of 240 g of sodium chloride dissolved in 2 l of water, to prepare the water phase. In a 20 L-volume stainless-steel container, the above oil phase and the above water phase were mixed and subjected to treatment with a high-speed disperser (homogenizer), and by adjusting the revolution rate and dispersion time, the maximum oil droplet particle diameter was controlled to be 5 μm.

Next, reaction was carried out for 7 hours at 60° C. while stirring at 150 rpm by using a normal stirring blade. The thus generated crosslinked polymer particles were subjected to centrifugal separation (2000 rpm, for 10 minutes) and the supernatant was discarded. After the precipitate was dispersed in 12 l of 70° C. water (by use of ultrasonic cleaner), stirring was conducted for 3 hours at 70° C. This was subjected to suction filtration and the cake on the funnel was washed with 60 l of 70° C. water and then with 18 l of acetone. The cake was spread on a stainless-steel tray and air-dried and further dried under reduced pressure at 60° C. for 24 hours. The resultant was classified by use of an air separator. 1300 g of particles having a mass average particle diameter of 5.1 μm according to measurement by using a Coulter Counter (Multisizer 3, produced by Beckman Coulter, Inc.) was obtained.

To 50 g of the above obtained crosslinked polymer particles, 500 ml of pure water was added and the mixture was stirred at 60° C. for 5 hours. Then particles were taken out by filtration and washed with 2000 ml of 70° C. water and then with 300 ml of methanol. The resultant was spread on a stainless-steel tray and air-dried, and further dried under reduced pressure at 70° C. for 24 hours, to thereby obtain 48 g of packing material.

### 2. Evaluation of Column Performance

About 3 g of the thus obtained packing material was packed into a stainless steel column having an inner diameter of 4.6 mm and length of 150 mm by wet-packing method.

Eluent: Pure water,

Flow rate: 0.33 ml/min,

standard sample: pullulan 0.1 mass %,

molecular weight of pullulan: 758000, 338000, 194000, 95400,
46700, 20800, 12000, 5300
(All these are products Shodex STANDARD
P-82, produced by SHOWA DENKO. K.K.),

molecular weight: 2930(produced by SHOWA DENKO. K.K.),

molecular weight: 1330(produced by SHOWA DENKO. K.K.),

Detector: RI,

Injection amount: 100 μl

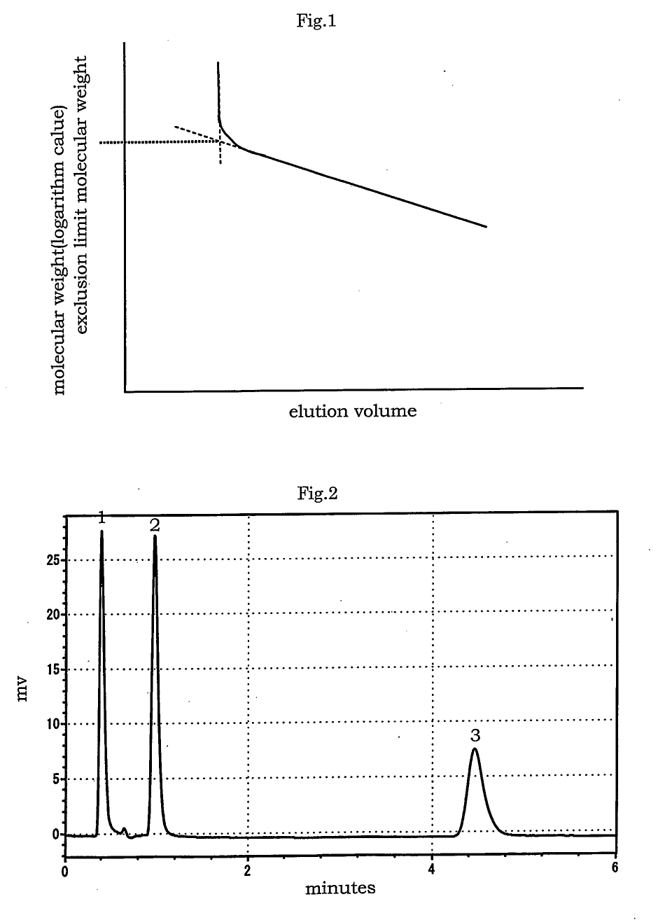

With respect to pullulan of each molecular weight, elution point was measured and the elution volume was calculated from the retention time to thereby prepare a calibration curve. That is, in a graph where the logarithm value of the molecular weight was represented by the vertical axis and the elution volume was represented by the horizontal axis, each dot was plotted to thereby form a curve line (FIG. 1). The exclusion limit molecular weight was defined as the vertical axis value at the point where the extended line of the inclined straight line intersected with the extended line of a line parallel to the vertical axis. The obtained exclusion limit molecular weight of the packing material was 20000.

### 3. Evaluation on Recovery Rate of BSA

(Bovine Serum Albumin)

The packing material was packed in a column having a diameter of 4.6 mm and a length of 50 mm.

The BSA recovery rate in a case of injecting bovine serum albumin (produced by Sigma-Aldrich Co., hereinafter sometimes abbreviated as “BSA”) into this column was calculated, based on that the peak area of BSA in case of not using a column (instead of a column, a tube of polytetrafluoroethylene (having an inner diameter of 0.5 mm and a length of 10 m) was used and measurement was conducted) was defined as 100%.

Eluent: 10 mM ammonium acetate/acetonitrile
=850 g/150 g

Flow rate: 1 ml/min,

Column temperature: 30° C.,

Sample: BSA 7 mg/ml,

Injection amount: 10 μl,

Detector: UV (220 nm).

BSA was observed as one peak at the exclusion limit and from the peak area, it was confirmed that 98 of the BSA was eluted out.

### 4. Evaluation on Separation Performance of the Column

For comparison of the packing materials in static interaction by taking hydrophobicity of each of the packing material into consideration, relative static interaction was calculated from the following equation:

α=k_{caffeine}/kₜₒₗᵤₑₙₑ

k_{caffeine}: retention coefficient of caffeine,
kₜₒₗᵤₑₙₑ: retention coefficient of toluene,
kᵣ: (tᵣ−t₀)/t₀,
tᵣ: retention time of each sample (time point at a peak),
r: caffeine or toluene,
t₀: non-retention time

This value represents a ratio between hydrophobic interaction and static interaction, and when this value is large, retention of highly polar low molecular weight compound can be high and moreover, too much retardation in elution of hydrophobic low molecular weight compound can be avoided. In other words, the larger the value (up to some degree), the more efficiently separation between hydrophilic polymer eluting out at an initial stage and highly polar low molecular weight compound can proceed, and thus a column, which can save its users a long period of time for waiting for highly hydrophobic low molecular weight compound to be eluted out, can be provided.

### Analysis Conditions:

Eluent: 10 mM ammonium acetate/acetonitrile=750 g/250 g,

Flow rate: 1 ml/min

Column temperature: 40° C.,

De: UV (254 nm),

Injection amount: 10 μl,

Sample: BSA 700 mg/L, Caffeine 10 mg/L, toluene 150 mg/L,

Result: α=0.086

In FIG. 2, a chromatogram is shown. Peaks 1, 2 and 3 indicate the peaks of BSA, caffeine and toluene, respectively, After BSA was eluted out at the exclusion limit (0.39 minutes), caffeine was eluted out at 0.97 minutes, and toluene was eluted out at 4.45 minutes. With separation between BSA and caffeine being good and elution of toluene being not too late, analysis under isocratic condition could be completed quickly.

### Example 2

### 1. Production of Co-Polymerized Type Packing Material

1200 g of crosslinked polymer particles was obtained by conducting polymerization and air classification in the same manner as in Example 1 except that instead of using 2000 g of glycerine dimethacrylate, 1880 g of glycerine dimethacrylate and 120 g of glycidyl methacrylate were used. The particle diameter of the particles was 5.1 μm.

To 30 g of the above obtained crosslinked polymer particles, 500 ml of 0.3M formic acid aqueous solution (the pH of which was adjusted to 3.0 by using 1N sodium hydroxide aqueous solution) was added and the mixture was stirred at 60° C. for 5 hours. Then the particles were taken out by filtration and washed with 2000 ml of 70° C. water and then with 300 ml of methanol. The resultant was spread on a stainless-steel tray and air-dried, and further dried under reduced pressure at 70° C. for 24 hours, to thereby obtain 30 g of packing material.

2. The exclusion limit molecular weight (with analysis conditions being the same as in Example 1) was 20000.
3. Evaluation of recovery rate of BSA (with analysis conditions being the same as in Example 1):

93% of BSA was recovered.

4. Evaluation on separation performance of column (with analysis conditions being the same as in Example 1): α=0.087

Thus, a packing material having properties similar to Example 1 was obtained.

### Comparative Example 1

### 1. Production of Packing Material

A packing material having a mass average particle diameter of 4.9 μm was obtained in the same manner in Example 1 except that instead of 2000 g of glycerine dimethacrylate, 2000 g of ethylene dimethacrylate was used.

2. The exclusion limit molecular weight (with analysis conditions being the same as in item 2 of Example 1) was 30000.
3. Evaluation of recovery rate of BSA (with analysis conditions being the same as in item 3 of Example 1)

90% of BSA was recovered.

4. Evaluation on separation performance of column (with analysis conditions being the same as in item 4 of Example 1): α=0.028

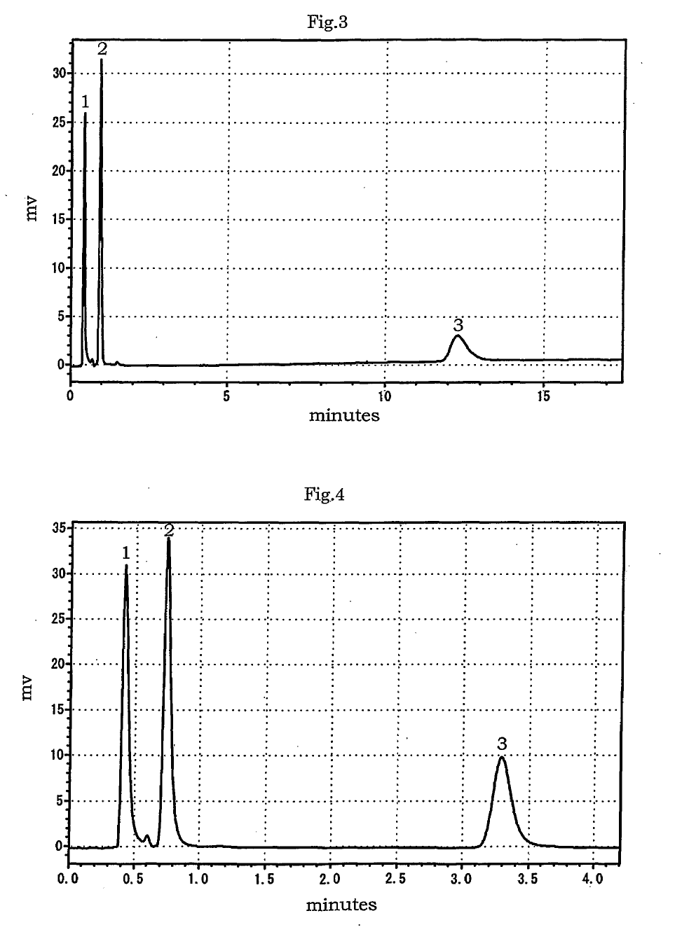

The value of α was smaller than that of the packing material of Example 1. A chromatogram is shown in FIG. 3. Peaks 1, 2 and 3 indicate the peaks of BSA, caffeine and toluene, respectively. In this chromatogram, for the purpose of comparison with FIG. 2), the time axis line is scaled down so that the distance between the BSA peak and the toluene peak in FIG. 3 can be almost the same as the distance in FIG. 2. The elution time point for toluene was at about 12 minutes, which was significantly retarded as compared with the time point in the vicinity of 5-minute point of Example 1. Therefore, it can be said that the column is unsuitable for quick analysis under isocratic condition.

### Comparative Example 2

### 1. Production of Packing Material

A packing material having a mass average particle diameter of 5.1 μm was obtained in the same manner as in Example 1 except that instead of using 2000 g of glycerine dimethacrylate, 1000 g of ethylene dimethacrylate and 1000 g of glycerine dimethacrylate were used.

2. The exclusion limit molecular weight (with analysis conditions being the same as in item 2 of Example 1) was 50000.
3. Evaluation of recovery rate of BSA (with analysis conditions being the same as in item 3 of Example 1)

93% of BSA was recovered.

4. Evaluation on separation performance of column (with analysis conditions being the same as in item 4 of Example 1): α=0.044

The value of α was smaller than that of the packing material of Example 1. A chromatogram is shown in FIG. 4. Peaks 1, 2 and 3 indicate the peaks of BSA, caffeine and toluene, respectively. In this chromatogram, for the purpose of comparison with FIG. 2), the time axis line is scaled up so that the distance between the BSA peak and the toluene peak in FIG. 4 can be almost the same as the distance in FIG. 2. The elution time point for toluene was not too much retarded and was appropriate, however, separation of caffeine was inferior to that in Example 1.

### Comparative Example 3

1. As packing material, a commercially available packing material, GF-310 4B (polyvinyl alcohol-base packing material having a mass average particle diameter of 5 μm, produced by SHOWA DENKO K.K.) was used.
2. The exclusion limit molecular weight: 40000 according to the product catalogue
3. Evaluation of recovery rate of BSA (with analysis conditions being the same as in item 3 of Example 1)

98% of BSA was recovered.

4. Evaluation on separation performance of column (with analysis conditions being the same as in item 4 of Example 1): α=0.019

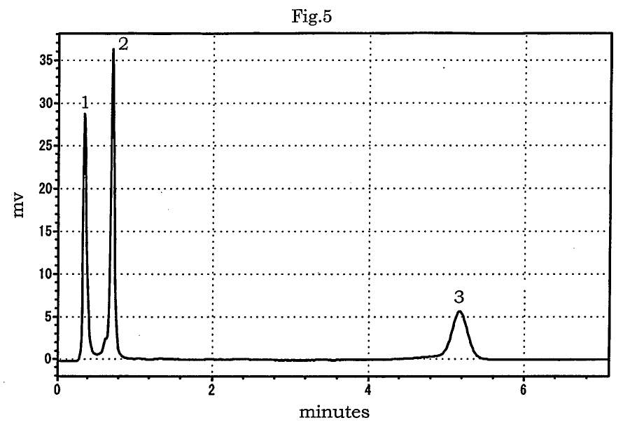

The value of α was smaller than that of the packing material of Example 1. A chromatogram is shown is FIG. 5. Peaks 1, 2 and 3 indicate the peaks of BSA, caffeine and toluene, respectively. In this chromatogram, for the purpose of comparison with FIG. 2, the time axis line is scaled down so that the distance between the BSA peak and the toluene peak in FIG. 5 can be almost the same as the distance in FIG. 2. Separation of BSA and caffeine was inferior.

### Example 3

### Analysis using an MS as Detector

A stainless-steel column having a diameter of 2.0 mm and a length of 50 mm, in which packing material of Example 1 was packed by wet-packing method, was used. As sample containing low molecular weight compound, a sample containing three kinds of chemicals, that is, barbital, phenobarbital and hexobarbital represented by the following formulae, was chosen,

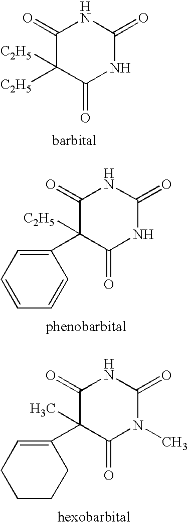

and as water-soluble polymer matrix, bovine serum albumin) (BSA, molecular weight about 67000) was selected. As LC-MS system, LCQ Advantage (Thermo Electron K.K.) was connected to Agilent 1100 series HPLC system (produced by Agilent Technologies) and used by electrospray ionization (ESI). Analysis was conducted by eluting for 5 minutes under isocratic condition (0.20 ml/min, splitless) at column temperature of 30° C. with a mobile phase of 10 mM ammonium acetate/acetonitrie=70 ml/30 ml.

First, 10 μl of a sample containing only the drugs (each 5 μg/ml) dissolved in ion-exchange water was injected, and measurements were conducted with a UV detector (220 nm) and by selected ion monitoring in the ESI-negative ion mode (ionization voltage: 5 kV). Next, 10 μl of a sample containing the three drugs (each 5 μg/ml) and BSA (0.7 mg/ml) dissolved in ion-exchange water was injected, and measurements were conducted similarly, except that in the latter measurement, elution liquid with BSA being eluted at a high concentration (up to 1.2 min) was not introduced to MS. Results:

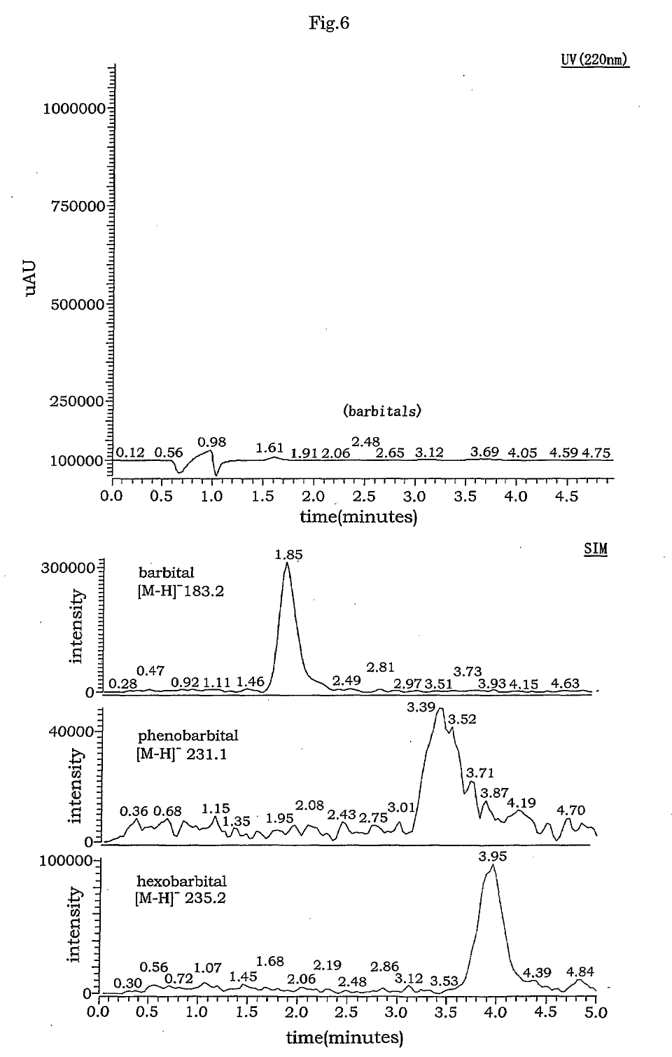

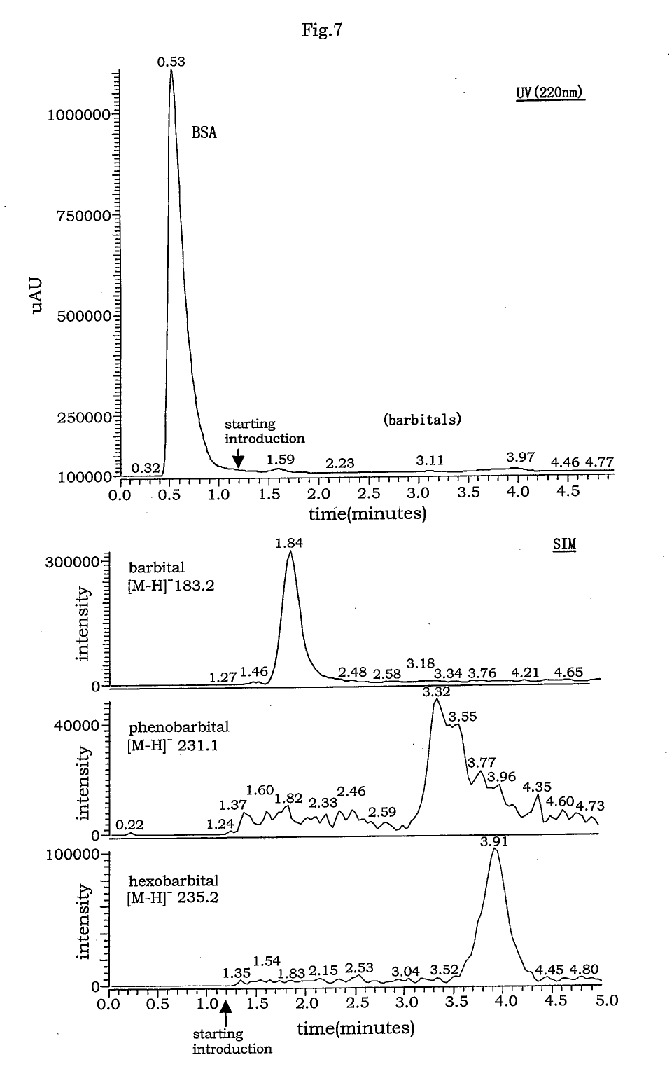

Analysis result on the drug sample is shown in FIG. 6 and analysis result on the drug sample containing BSA is shown in FIG. 7. The maximum value on the vertical axis of UV detection chromatogram is tailored to the peak top value of BSA. So is the maximum value on the vertical axis of SIM chromatogram, in measurement with the same m/z.

From the result of the analysis on the drug sample which preceded, each of the drugs was detected as ions of deprotonated molecules, [M-H]⁻, with high sensitivity. It was found that barbital (m/z 183.2), phenobarbital (m/z 231.1) and hexobarbital (m/z 235.2) were well separated and eluted in the retention time range of 1.3 to 4.5 minutes.

In the subsequent analysis on the drug sample containing BSA, since elution of BSA concentrated on the retention time rage of 0.4 to 0.8 minutes, there was enough time before the last moment of switching the flow path (1.2 minutes) immediately before elution of barbital. The obtained SIM chromatogram on each of the drugs accorded very well with that in the result on the sample cot containing BSA in shapes and heights of peaks. Sensitivity to phenobarbital was low as compared with sensitivity to the other two drugs. However, no difference caused by presence or absence of BSA was observed.

In a case where BSA exceeds the exclusion limit of the packing material, since size-exclusion mode works, reversed-phase interaction can be negligibly small, and as a result, it can be assumed that BSA was eluted out in a mass at the initial end. In contrast, barbitals having small molecular weigh entered into pores and were separated in the reverse-phase mode. it can be assumed that since retention was enhanced to some extent through hydrogen-bonds with hydroxyl groups scattered on the inner surface of the pores, separation from BSA was further accelerated.

1. A method for analyzing low molecular weight compound in a sample containing water-soluble polymer and low molecular weight compound, wherein the analysis is conducted by using a high-performance liquid chromatography which uses a column using a packing material comprising crosslinked organic polymer obtained by using as starting material monomer a compound having two ethylenic carbon-carbon double bonds and one hydroxyl group at 90 mass % or more.

2. The analysis method according to claim 1, wherein the compound having two ethylenic carbon-carbon double bonds and one hydroxyl group is glycerin dimethacrylate.

3. The analysis method according to claim 1, wherein the exclusion limit molecular weight of the packing material measured with pullulan is 30000 or less.

4. The analysis method according to claim 1, wherein the high performance liquid chromatography analysis is conducted under isocratic condition by using an eluent containing 15 to 40 mass % of organic solvent compatible with water and 85 to 60 mass % of aqueous buffer.

5. The analysis method according to claim 4, wherein the organic solvent compatible with water is methanol and/or acetonitrile.

6. The analysis method according to claim 5, wherein the organic solvent compatible with water is acetonitrile.

7. The analysis method according to claim 1, wherein the water-soluble polymer is contained in biological components and is derived from the living body.

8. The analysis method according to claim 1, wherein the water-soluble polymer is serum albumin.

9. The analysis method according to claim 1, wherein the packing material used in the method consists of porous spherical particles having a mass average particle diameter of 0.1 to 100 μm.

10. The analysis method according to claim 1, wherein the low molecular weight compound separated by high performance liquid chromatography is analyzed by using a mass analyzer.

11. A packing material used in analysis on low molecular weight compound in a sample containing water-soluble polymer and low molecular weight compound with high performance liquid chromatography, consisting of a crosslinked organic polymer compound obtained by using glycerin dimethacrylate at 90 mass % or more as raw material,
having the exclusion limit molecular weight measured with pullulan of 30000 or less but 3000 or more and having a mass average particle diameter of 0.1 to 100 μm.

12. A column used in analysis on low molecular weight compound in a sample containing water-soluble polymer and low molecular weight compound with high performance liquid chromatography, using the packing material described in claim 11.

13. The analysis method according to claim 2, wherein the exclusion limit molecular weight of the packing material measured with pullulan is 30000 or less.
